(19) United States
(12) Patent Application Publication
(10) Pub. No.: US 2025/0236046 A1
(43) Pub. Date: Jul. 24, 2025

(54) COMPACT LOG SPLITTER

(71) Applicant: BRIG INNOVATION INC., Shefford (CA)

(72) Inventor: Wallace GRUBB, Shefford (CA)

(21) Appl. No.: 18/853,467

(22) PCT Filed: Apr. 3, 2023
(86) PCT No.: PCT/CA2023/050450

§ 371 Date: Oct. 2, 2024

Related U.S. Application Data
(60) Provisional application No. 63/327,514, filed on Apr. 5, 2022.

(51) Int. Cl. B27L 7/06; E02F 3/36

(52) U.S. Cl. CPC B27L 7/06; E02F 3/3677

(57) ABSTRACT

The compact log splitter comprises a main body, a tool coupling member carried by the main body, for operative coupling to a tool handling device, and first and second jaws carried by the main body, the jaws each being movable relative to the main body along a jaw movement direction, the jaws further being movable towards and away from each other between a closed position in which they are near or adjacent to each other and an opened position in which they are spaced-apart compared to the closed position, at least one of the jaws comprising a cutting tool for splitting logs that is in facing register with the other one of the jaws. A jaw actuation mechanism is carried by the main body and operatively connected to the first and second jaws, allowing the jaws to be moved between the opened and closed positions. The compact log splitter has substantially the same width when the jaws are in the opened position and in the closed position. When the first and second jaws are in the opened position, the jaw actuation mechanism is mostly located between parallel planes that are perpendicular to the jaw movement direction and respectively located at the positions of the first and second jaws.

### FIELD OF THE INVENTION

The present invention relates to log splitters, and more particularly to a compact log splitter for use on a tool handling device.

### BACKGROUND OF THE INVENTION

Mechanical log splitters are well known devices for use in splitting logs. Some such heavy-duty log splitters are installed on multipurpose construction vehicles, such as skid-steers, backhoes or excavators. More specifically, these vehicles have a hinged tool arm that includes a boom segment and a tool support segment and that can be equipped with an adapted hydraulic tool, such as a log splitting tool.

The enclosed FIG. 1 shows a conventional construction vehicle 30 in the form of an excavator that comprises a vehicle body 32 movable over ground by means of tracks 34, a vehicle cab 36, a control panel 38 that typically includes a number of levers, and a motor (concealed in FIG. 1). Vehicle 30 further comprises a tool arm 40 that has a boom 42 to which a tool segment 44 is attached. Tool arm 40 may include all components conventionally found on such devices, including hydraulic actuators (e.g., pumps) to pivot and displace the tool segment 44 relative to vehicle main body 32; all of which may be controlled from control panel 38. An arm coupling 46 is provided at the free end of tool segment 44 to operatively attach a tool to tool arm 40. This tool can be a bucket, a jackhammer or the like; but as shown in FIG. 1, it may also be a prior art log splitter 50.

Prior art log splitter 50 has a main body 51 that carries a coupling 52 that operatively attaches the log splitter main body 51 to the tool support segment 44 of the tool arm 40. Log splitter 50 also includes a channel 53 formed within main body 51 wherein a bar 54 is carried by and extends through main body 51, such that first and second ends 54a, 54b of bar 54 project on either side of main body 51. A first jaw 56 is carried at first end 54a of bar 54. A second jaw 58 is carried by main body 51. A log splitting blade 58a is provided on second jaw 58 in facing register with an abutment plate 56a provided on first jaw 56. A hydraulic cylinder 62 is attached at its first end to main boy 51 and at its other end to second end 54b of bar 54.

In use, upon actuation of hydraulic cylinder 62, bar 54 will slide within channel 53 such that first jaw 56 will move towards and away from second jaw 58. More particularly, first jaw 56 is movable between a closed position in which it is near second jaw 58 and an opened position in which it is located away from second jaw 58. A log (not shown) to be split is installed between first and second jaws 56, 58 when first jaw 56 is in its opened position, then first jaw 56 is moved towards its closed position until the log is split when being sandwiched between blade 58a and abutment plate 56a that close in on one another.

The total width L3 of prior art log splitter 50 is consequently always essentially equal to the length of bar 54. Indeed, as first jaw 56 moves between its closed and opened positions, the length L1 on the side of first jaw 56 will be inversely proportional to the length L2 on the side of hydraulic cylinder 62. When first jaw 56 is in its closed position, hydraulic cylinder 62 is extracted and bar second end 54b projects far away from main body 51. When first jaw 56 is its opened position, bar first end 54a projects far away from main body 51, and bar second end 54b still projects of about half the length of hydraulic cylinder 62, which is in its retracted position.

In practice, the operator of log splitter 50 will also use the jaws 56, 58 to grip logs that lie on the ground, before closing first jaw 56 to split the log being gripped. But, the configuration of log splitter 50 is cumbersome because of the wide total width L3, and particularly because of second end 54b that significantly protrudes beyond main body 51 at all times. As log splitter 50 is operated to move logs on the ground and to grip them, bar 54 gets in the way. This is an important problem since many objects may get in the way of picking up the logs to split them with the log splitter 50, including other logs, trees, rocks, uneven ground and the like.

Another problem with the prior art log splitter 50 is that since the log splitter 50 only pushes from one side, namely, only first jaw 56 moves, a log being gripped significantly slides on the ground and it becomes dirty with mud or dirt, which is undesirable since the logs are often destined to retail sale where customers prefer clean logs.

Yet another problem with prior art log splitters such as the one shown in FIG. 1, is that the weight of log splitter 50 is off-centered relative to the position of tool segment 44. This is a result of one jaw 56 moving away from the other jaw 58, and the more the jaw 56 is opened, the more the weight is off-centered. This induces stresses from the torque applied by the off-centered center of gravity of log splitter 50, and this problem is even worse when a log is being gripped by the log splitter 50 for splitting.

### SUMMARY OF THE INVENTION

The present invention relates to a compact log splitter comprising:
a main body;
a tool coupling member carried by said main body, for operative coupling to a tool handling device;
first and second jaws carried by said main body, said jaws each being movable relative to said main body along a jaw movement direction, said jaws further being movable towards and away from each other between a closed position in which they are near or adjacent to each other and an opened position in which they are spaced-apart compared to said closed position, at least one of said jaws comprising a cutting tool for splitting logs that is in facing register with the other one of said jaws; and
a jaw actuation mechanism carried by said main body and operatively connected to a said first and second jaws, allowing said jaws to be moved between said opened and closed positions;
   wherein said compact log splitter has substantially the same width when said jaws are in said opened position and in said closed position, and wherein when said first and second jaws are in said opened position, said jaw actuation mechanism is mostly located between parallel planes that are perpendicular to said jaw movement direction and respectively located at the positions of said first and second jaws.

In one embodiment, the width of said compact log splitter is substantially the same as the longest distance between said jaws when they are in said opened position.

In one embodiment, the compact log splitter further defines a central plane that is perpendicular to said jaw movement direction and located approximately at the same distance from said first jaw and from said second jaw at all positions of said jaws, with the center of gravity of said compact log splitter being located within or close to said central plane.

In one embodiment, said jaw actuation mechanism comprises first and second linear actuators each operatively connected to a respective one of said first and second jaws for moving said respective one of said first and second jaws, such that the concurrent actuation of said first and second actuators will move said first and second jaws between said opened and closed positions, wherein said first jaw is movable parallel to said second linear actuator and the second jaw is movable parallel to the first linear actuator when said jaws move between said opened and closed second positions.

In one embodiment, said first and second linear actuators respectively comprise first and second hydraulic cylinders each comprising a cylinder barrel attached to one of said main body and a respective one of said first and second jaws, and a piston rod attached to the other one of said main body and a respective one of said first and second jaws, said hydraulic cylinders for connection to a hydraulic circuit allowing selective extraction and retraction of the piston rods of said first and second hydraulic cylinders in opposite directions, wherein the first jaw is movable parallel to the second hydraulic cylinder and the second jaw is movable parallel to the first hydraulic cylinder when said piston rods are extracted and retracted.

In one embodiment, said main body comprises first and second parallel elongated housings that carry first and second slider members that are each slidable within a respective one of said first and second housings, with each slide member carrying a respective one of said first and second jaws, and with said hydraulic cylinders each being connected to a respective one of said first and second slider tubes for displacing said slider tubes in said housings when said jaws are displaced between said opened and closed positions.

In one embodiment, said slider members are slider tubes that each snugly fit within a respective said housing.

In one embodiment, said first jaw comprises a cutting blade and said second jaw comprises an abutment plate in facing register with said cutting blade.

The invention also relates to a vehicle equipped with a compact log splitter, said vehicle comprising a vehicle body movable over ground, a motor carried by said main body, and a tool arm carried by said main body, said tool arm comprising an arm coupling member, said compact log splitter comprising:
a main body;
a tool coupling member carried by said main body operatively coupled to said arm coupling member of said tool arm;
first and second jaws carried by said main body, said jaws each being movable relative to said main body along a jaw movement direction, said jaws further being movable towards and away from each other between a closed position in which they are near or adjacent to each other and an opened position in which they are spaced-apart compared to said closed position, at least one of said jaws comprising a cutting tool for splitting logs that is in facing register with the other one of said jaws; and.
a jaw actuation mechanism carried by said main body and operatively connected to a said first and second jaws, allowing said jaws to be moved between said opened and closed positions;
   wherein said compact log splitter has substantially the same width when said jaws are in said opened position and in said closed position, and wherein when said first and second jaws are in said opened position, said jaw actuation mechanism is mostly located between parallel planes that are perpendicular to said jaw movement direction and respectively located at the positions of said first and second jaws.

### BRIEF SUMMARY OF THE DRAWINGS

In the annexed drawings:

FIG. 1 is a perspective view of an excavator vehicle equipped with a prior art log splitter;

FIG. 2 is a side elevation of the excavator vehicle instead equipped with a compact log splitter according to the present invention;

FIG. 3 is a top perspective view, at an enlarged scale, of the log splitter of FIG. 2;

FIG. 4 is an exploded top perspective view, at a slightly smaller scale, of the log splitter of FIG. 3;

FIGS. 5A and 5B are partial top perspective views of the log splitter of FIG. 3 respectively showing the first and second jaws in their opened and closed positions, with the coupling and the top walls of the housings and of the slider tubes being removed to show inner components of the log splitter;

FIGS. 6A and 6B are bottom perspective views of the log splitter of FIG. 3 respectively showing the first and second jaws in their opened and closed positions;

FIGS. 7A and 7B are partial bottom perspective views of the log splitter of FIG. 3 respectively showing the first and second jaws in their opened and closed positions, with the housings being removed to show inner components of the log splitter;

FIG. 8 is a diagram schematically showing the hydraulic circuit of the log splitter and of the excavator vehicle; and

FIGS. 9A and 9B are side elevations of the log splitter of FIG. 3, respectively showing the first and second jaws in their opened position and in their closed position.

### DETAILED DESCRIPTION OF THE EMBODIMENTS

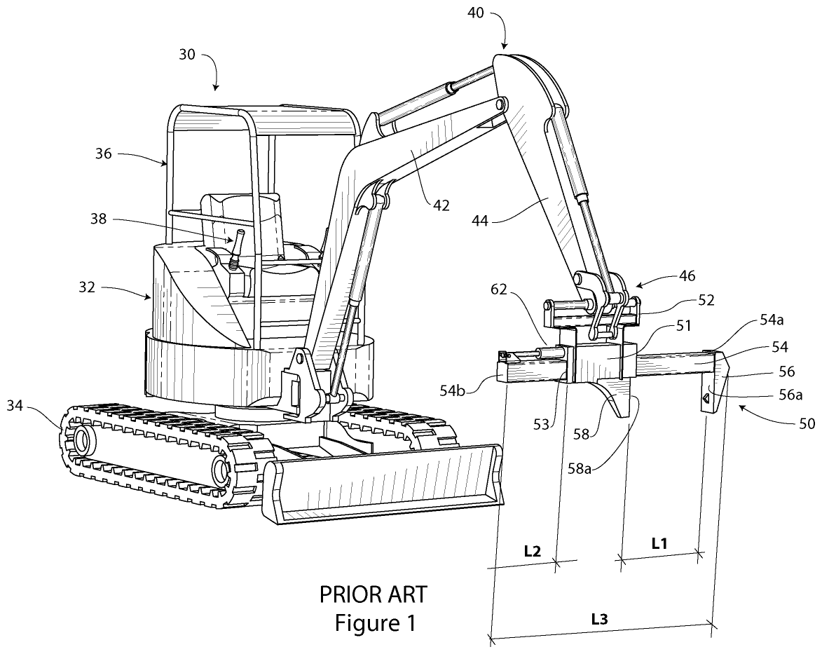

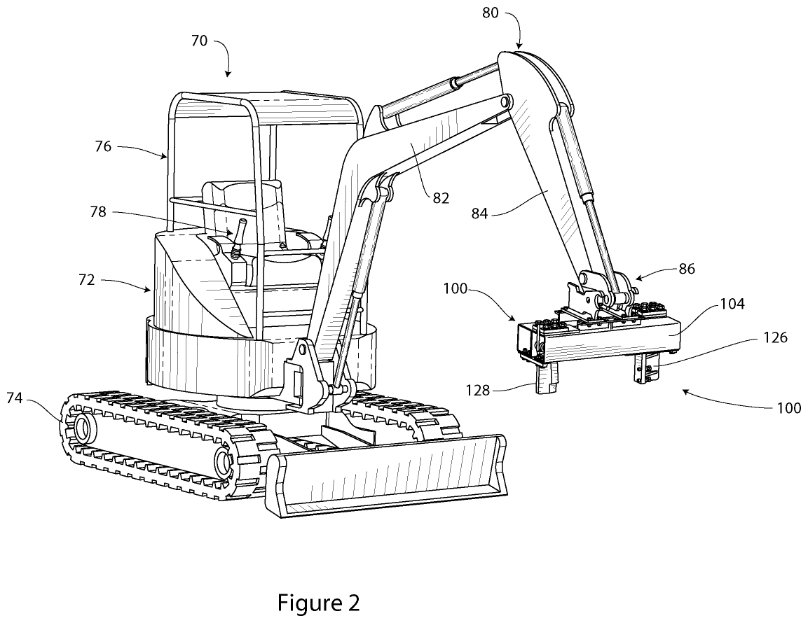

FIG. 2 shows the same conventional construction vehicle 70 as that of FIG. 1, i.e., in the form of an excavator that comprises a vehicle body 72 movable over ground by means of tracks 74, a vehicle cab 76, a control panel 78 that typically includes a number of levers, and a motor (concealed in FIG. 2). Vehicle 70 further comprises a tool arm 80 that has a boom 82 to which a tool segment 84 is attached. Tool arm 80 may include all components conventionally found on such devices, including hydraulic actuators (e.g., pumps) to pivot and displace the tool segment 84 relative to vehicle main body 72; all of which may be controlled from control panel 78. An arm coupling 86 is provided at the free end of tool segment 84 to operatively attach a tool to tool arm 80.

According to the present invention, the tool being attached to vehicle 70 is an inventive compact log splitter 100 instead of one of the prior art devices.

It is understood that while an excavator has been shown in FIG. 2 as the device for carrying and handling log splitter 100, any other suitable tool handling device could alternately be used, including a mobile tool handling device including a vehicle or a stationary tool handling device mounted resting on the ground.

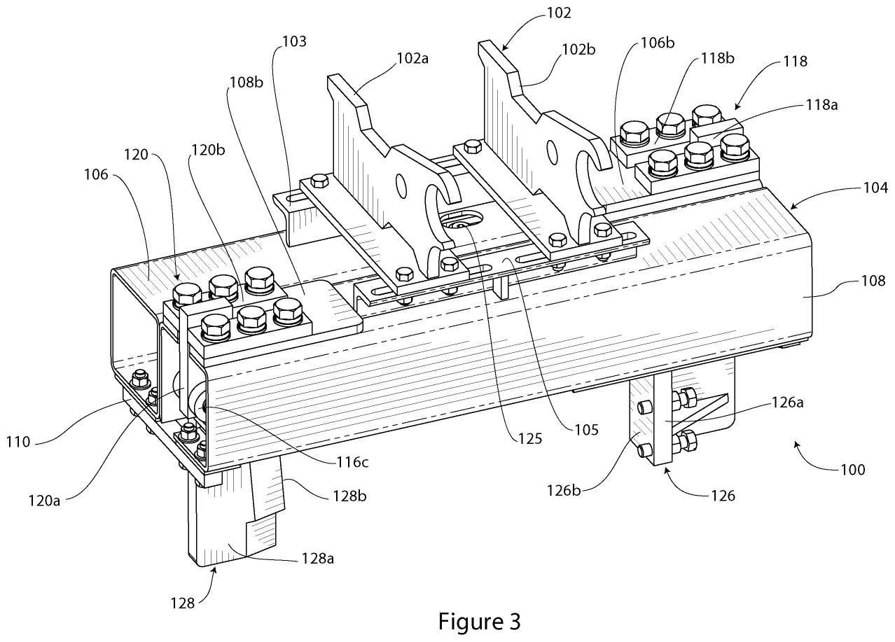

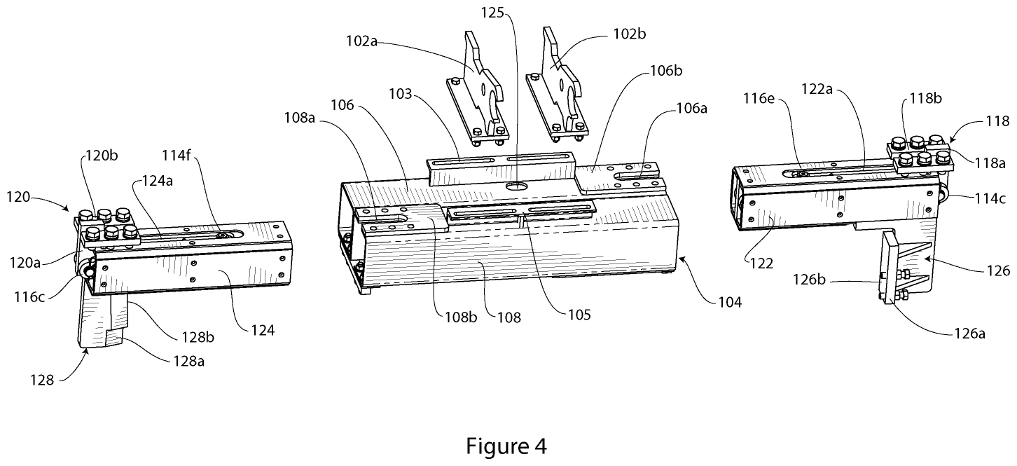

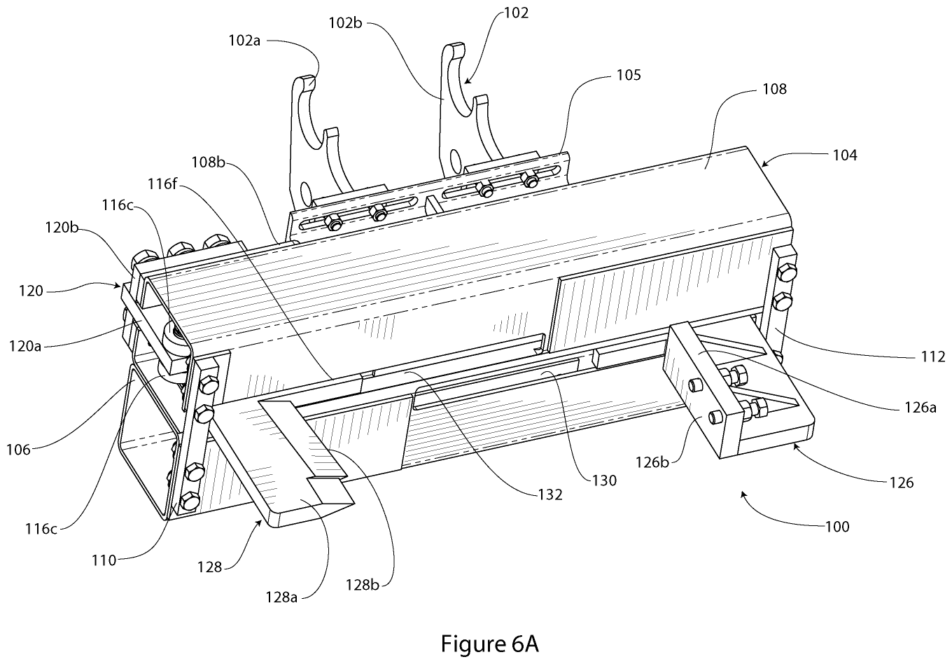

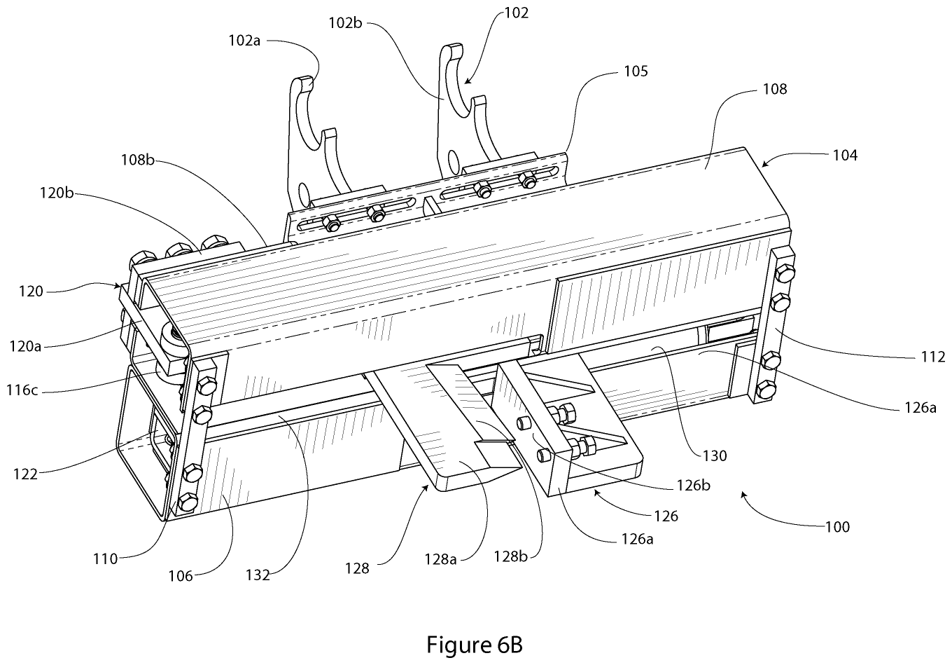

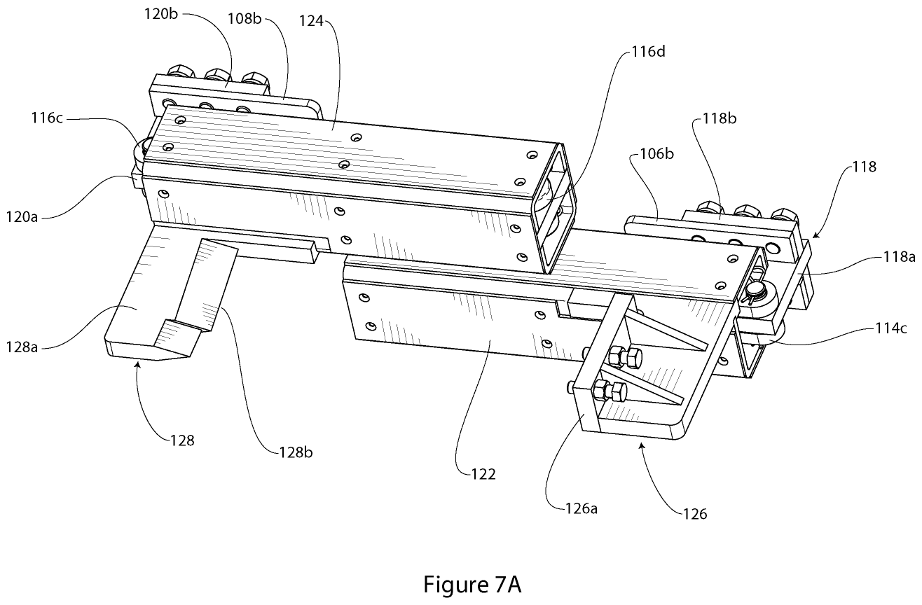

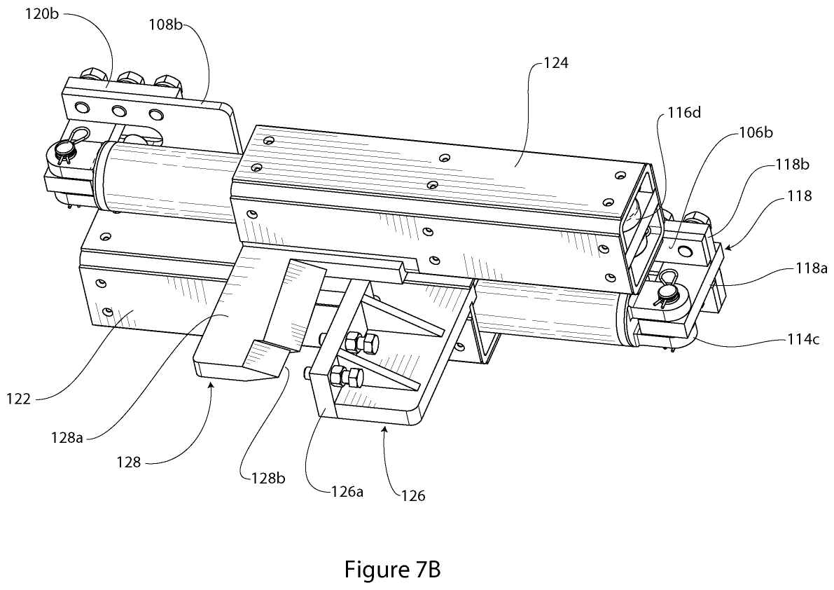

FIGS. 3, 4, 5A, 5B, 6A, 6B, 7A, 7B show that log splitter 100 comprises a tool coupling member 102 including two coupling plates 102a, 102b to operatively couple log splitter 100 to tool arm 80, and more particularly, to the arm coupling 86. Coupling members 102a, 102b may have any suitable shape and configuration that will be complementary to arm coupling 86, considering that arm coupling 86 will typically be universal for use with other types of tools such as a bucket, a jackhammer or the like.

Log splitter 100 further comprises a main body 104 that includes two elongated cross-sectionally square hollow housings 106, 108 that are fixedly attached to each other in parallel, side-by-side fashion by welding and that are attached to coupling member 102 by means of respective attachment plates 103, 105. Housings 106, 108 each house a respective elongated cross-sectionally square hollow slider tubes 122, 124 that have a cross-section that is smaller than the cross-section of housings 106, 108 such that each slider tube 122, 124 snugly fits within a corresponding housing 106, 108 and may longitudinally slide therein. Slider tubes 122, 124 are further shorter than housings 106, 108 such that they may slide in housings 106, 108 without extending outside of housings 106, 108. In the embodiment shown in the drawings, a low-friction liner is used between slider tubes 122, 124 and housings 106, 108, such as an Ultra High Molecular Weight (UHMW) plastic liner. This liner may be replaceable as it becomes worn over time, representing a much less expensive option than replacing slider tubes 122, 124 or housings 106, 108.

Housing 106 and slider tube 122 house a first hydraulic cylinder 114, and housing 108 and slider tube 124 house a second hydraulic cylinder 116. Hydraulic cylinders 114, 116 each comprise a cylinder barrel 114a, 116a that allows extraction and retraction of a piston rod 114b, 116b longitudinally within their respective housings 106, 108.

The cylinder barrels 114a, 116a are attached to their respective housings 106, 108 by means of respective cylinder connectors 118, 120. Each cylinder connector 118, 120 comprises a connector plate 118a, 120a to which a barrel mount 114c, 116c of cylinder barrels 114a, 116a is pivotally attached. Connector plates 118a, 120a extend through slots 106a, 108amade in housings 106, 108 and through slots 122a, 124a made in slider tubes 122,124 and are fixedly attached atop housings 106, 108 by means of attachment plates 118b, 120b that are bolted to intermediate plates 106b, 108b that are in turn both welded and bolted to housings 106, 108. The first and second cylinder barrels 114a, 116a are attached at ends of housings 106, 108 that are located opposite one another such that cylinder piston rods 114b, 116b will move parallel to each other, but in opposite directions when they are both extracted or retracted.

The piston rods 114b, 116b of hydraulic cylinders 114, 116 are pivotally attached at their rod mounts 114d, 116d to attachment plates 115, 117 that are in turn welded to one end of a respective one of slider tube 122, 124.

Consequently, as explained hereinafter, hydraulic cylinders 114, 116 may move slider tubes 122, 124 within housings 106, 108, without slider tubes ever projecting outside of housings 106, 108.

Hydraulic cylinders 114, 116 each further comprises a rod port 114e, 116e and a barrel port 114f, 116f that allow conventional connection to hydraulic fluid lines of a hydraulic circuit (see below). Openings 125 in housings 106, 108 (with only one opening 125 in housing 106 being visible in the drawings, the other being concealed), slots 106a, 108a in housings 106, 108 and slots 122a, 124a in slider tubes 122, 124 allow hydraulic fluid tubes (not shown in FIGS. 2-6) to be connected to hydraulic cylinders 114, 116.

Log splitter 100 further comprises a pair of log splitting jaws 126, 128 that are movable towards and away from each other. More particularly, first jaw 126 is fixedly attached to first slider tube 122 and extends out of first housing 106 through a first slot 130 that longitudinally extends underneath first housing 106 to allow first jaw 126 to slide within and along first slot 130. Second jaw 128 is fixedly attached to second slider tube 124 and extends out of second housing 108 through a second slot 132 that longitudinally extends underneath second housing 108 to allow second jaw 126 to slide within and along second slot 132. First jaw 126 is equipped with a pusher plate 126a that has an abutment surface 126b. Second jaw 128 is equipped with a wood cutting blade 128a that has a cutting edge 128b. Although the respective slider tubes 122, 124 are disposed side-by-side, the blade 128a and pusher plate 126a are disposed in offset fashion relative a central axis of their respective slider tubes 122, 124. Consequently, blade 128a and pusher plate 126a move along a common axis such that blade edge 128b of blade 128a remains in facing register with a central area of the abutment surface 126b of pusher plate 126a.

Fastening rods 110, 112 are bolted to housings 106, 108 to reinforce them at the extremity of slots 130, 132 and to prevent egress of first and second jaw 126, 128 from first and second slots 130, 132.

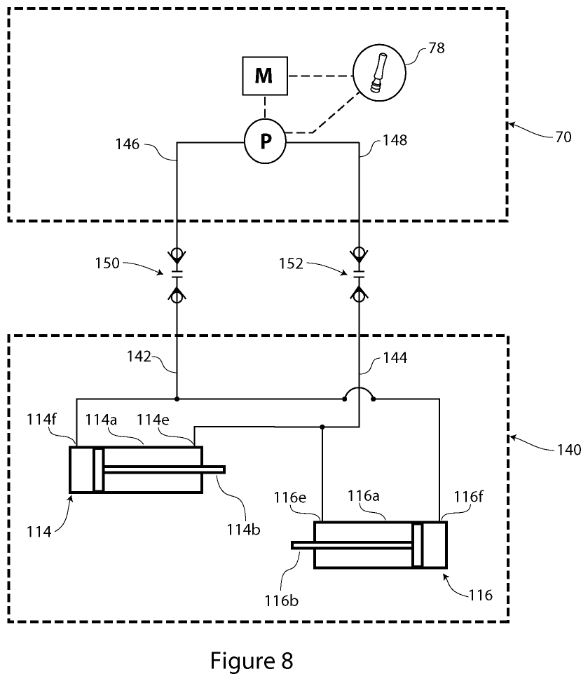

FIG. 8 is a diagram of the hydraulic circuit 140 of the log splitter 100 that shows that hydraulic cylinders 114, 116 are connected by means of two hydraulic fluid lines 142 and 144 to two hydraulic fluid lines 146, 148 of vehicle 70 through quick disconnect couplings 150, 152. Hydraulic fluid fed into first vehicle line 146 will flow through first log splitter line 142 to extract piston rods 114b, 116 while allowing fluid to be exhausted from cylinder barrels 114a, 116a through second log splitter line 144 and second vehicle line 148; and vice-versa for the retraction of piston rods 114b, 116b. Both vehicle lines 146, 148 are linked to a two-way hydraulic fluid pump P on vehicle 70, which is powered by the vehicle's motor M. Control panel 78 controls both the actuator of motor M and the actuation, and direction of flow, of pump P.

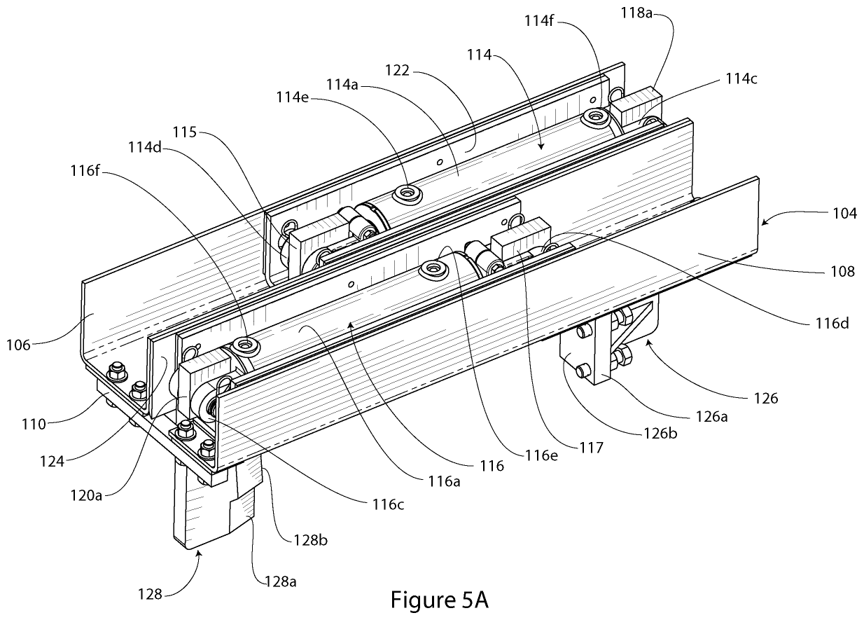

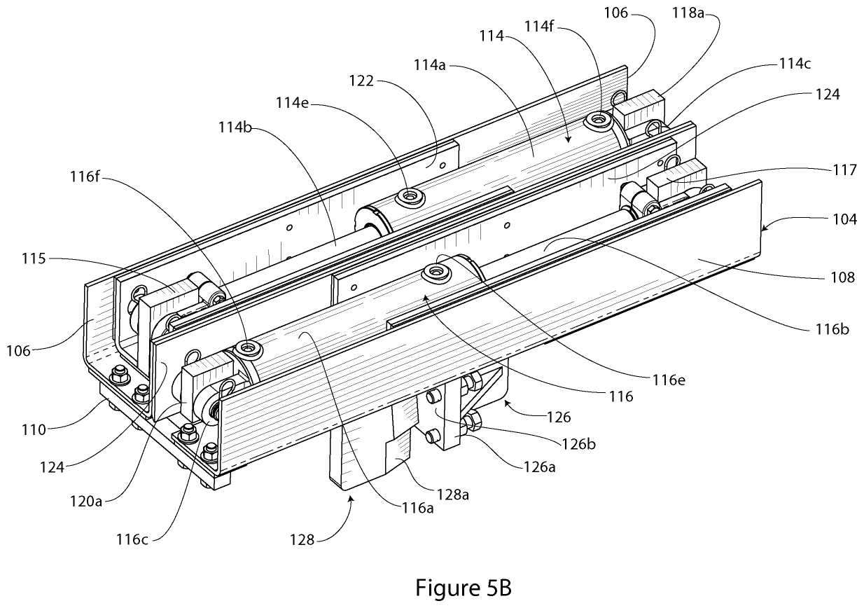

In use, through the instrumentality of control panel 78 and hydraulic circuit 140, the operator of vehicle 70 can control the extraction and retraction of piston rods 114b, 116b, which will impart a concurrent sliding movement of the corresponding slider tubes 122, 124 that carry first and second jaws 126, 128. First and second jaws 126, 128 will consequently slide towards or away from each other between an open position shown in FIGS. 3, 4, 5A, 6A and 7A; and a closed position shown in FIGS. 5B, 6B and 7B. First and second jaws 126, 128 are both movable relative to main body 104 along a jaw movement direction, and movable towards and away from each other.

In the opened position of jaws 126, 128, there is enough space for log splitter 100 to be positioned over or beside a log such that the log will fit between jaws 126, 128. Then, first and second jaws 126, 128 may be controlled to move towards their closed position wherein the edge 128b of blade 128a will move towards the abutment surface 126b of pusher plate 126a. Blade 128a and pusher plate 126a will cooperate to move the log until it is sandwiched between jaws 126, 128. The sharp blade edge 128b will then exert a shearing force against one end of the log as it abuts against abutment plate 126a. This will split the log.

Note that although this latter position is named the “closed” position of the jaws, it is not required that the blade edge 128b actually abut against the abutment surface 126b, there could remain a space between the two, as a log will likely be split even so. The closed position herein refers to a position where the jaws 126, 128 are closer to each other compared to the opened position, i.e. in which they are near each other or in which they abut against each other, and in which logs may be split. In one embodiment, there is actual abutment of first and second jaws 126, 128 in their closed position. In another embodiment, there is no actual abutment in their closed position.

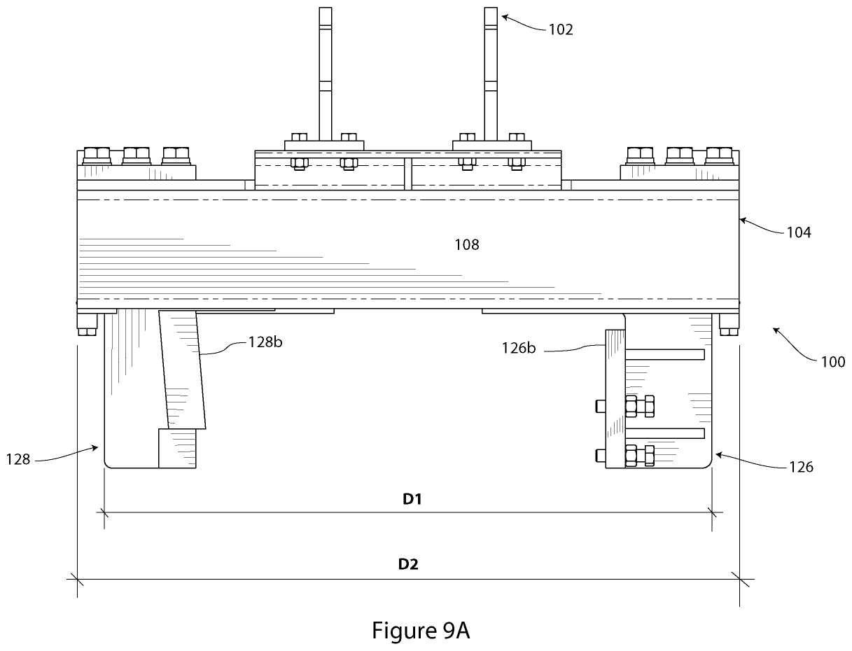

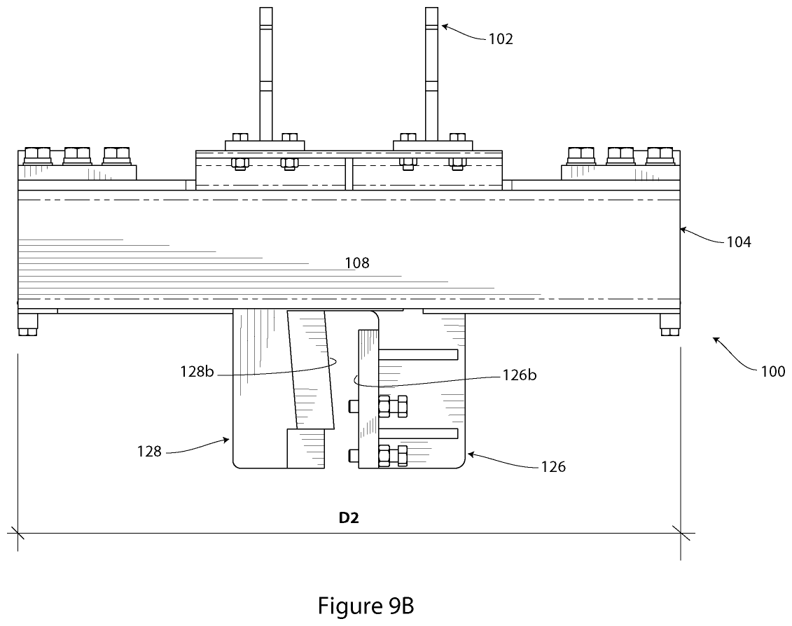

FIG. 9A shows that, in the opened position of jaws 126, 128, the width D2 of compact log splitter 100 is substantially equal to the external distance D1 between jaws 126, 128. Of course, jaws 126, 128 have a certain thickness such that effective width between blade edge 128b and pusher plate abutment surface 126b is actually smaller than the external width D1.

It can be seen by comparing the widths D1 and D2 in FIG. 9A that the compact log splitter 100 according to the present invention maximizes the ratio between the effective usable log area between jaws 126, 128 and the overall width D2. This compact arrangement is achieved by means of the dual movement of jaws 126, 128 that are displaced using respective hydraulic cylinders 114, 116 that are arranged to have their piston rods move parallel but in opposite directions. The first jaw 126 consequently essentially moves parallel to and along the length of the cylinder barrel 116a of the second hydraulic cylinder 116, while the second jaw 128 essentially moves parallel to and along the length of the cylinder barrel 114a of the first hydraulic cylinder 114. This parallel movement of the two hydraulic cylinders 114, 116 allows them to be mostly located between parallel planes that are perpendicular to said jaw movement direction and respectively located at the positions of first and second jaws 126, 128, i.e. most of hydraulic cylinders 114, 116 are located within length D1, above jaws 126, 128, when jaws 126, 128 are in their opened position.

FIG. 9B shows the closed position of jaws 126, 128 where jaws 126, 128 are near each other to split the log. It can be seen that the compact log splitter 100 has the same width D2 when jaws 126, 128 are in their opened and closed position. FIGS. 9A and 9B show that D2 is exactly the same in both figures. It is however envisioned that slight variations of this width could occur through particular log splitter configurations of different embodiments (not shown), so by “substantially the same” it is hereby meant that no significant increase in the width of the log splitter will occur between the closed and opened positions of the jaws 126, 128.

It can be further seen by comparing FIGS. 9A and 9B that when first and second jaws 126, 128 are in opened position, the width D2 of compact log splitter 100 remains substantially the same as the width D1 of jaws 126, 128 when they are in their opened position. By “substantially the same”, it is hereby meant that:
There is no significant variation of the width between the two positions as mentioned above; but also
The width D2 of the log splitter is only slightly larger than the width D1 between the jaws 126, 128.

Log splitter 100 may be moved as allowed by the tool arm 80 to which it is attached through the attachment with coupling 102, including in translation and in a pivotal displacement. Thus, log splitter 100 may be moved according to all three orthogonal axes and may further be pivoted to allow full positional flexibility to make grabbing and splitting logs easier.

Compared to the prior art, the compact log splitter 100 of the present invention is much less cumbersome and allows the operator to capture and handle logs much more easily with jaws 126, 128, using them similarly to a clamp to grab the logs before they are split. This minimizes accidental impacts with external objects since there are little if any components that protrude beyond jaws 126, 128. The simultaneous movement of two jaws also increases the speed at which a log is split, compared to using a single movable push plate that pushes a log towards a cutting blade like in the prior art. It also reduces by half the distance of the sliding of the log on the ground when it is being gripped by jaws 126, 128. By using two hydraulic cylinders instead of a single one, the structural stress imparted on the log splitter 100 is more spread out and requires components that are less resistant, less expensive and of smaller size—which again contributes to minimizing its encumbrance.

One other advantage of the compact log splitter 100 of the invention relies on its center of gravity being substantially aligned with the center of the tool arm coupling and of the tool segment 84 of tool arm 80. This is achieved due to the configuration of log splitter 100 that has its two jaws simultaneously movable towards and away from a central vertical plane that is perpendicular to the jaw movement direction and located midway between both jaws 126, 128; and by having the center of gravity of main body 104 and of the hydraulic cylinders 114, 116 be located on that central vertical plane. Of course, some slight offset of the center of gravity of log splitter 100 might exist relative to this central plane. For instance, the two jaws 126, 128 might not have the same weight. This is why, in the present specification, the center of gravity of log splitter 100 will be said to be substantially aligned with that of the above-mentioned central plane of log splitter 100 and of the tool arm coupling 86 and tool segment 84 of tool arm 80.

This particular advantage of having the center of gravity of log splitter 100 aligned with the central plane of log splitter 100 exists at all positions of jaws 126, 128, since they move symmetrically towards and away from the central plane. Furthermore, the jaws 126, 218 being always disposed symmetrically with respect to the log splitter central plane means that the center of gravity of log splitter 100 will remain within or close to its central plane even when loaded with a log to be split. Considering that logs can weigh e.g. 1000 pounds or more (454 kilograms), this is not trivial. Indeed, the combined weight of the log splitter 100 and of a log being gripped and carried for splitting, can induce important mechanical stresses in the log splitter 100 itself, but also, in the different components of tool arm 80. These mechanical stresses would be increased if a torque resulting from a off-centered center of gravity in the log splitter 100 itself, and in the log splitter 100 when it is loaded with a log.

In one embodiment (not shown), both jaws are provided with cutting blades instead of a single jaw 128 as in the embodiment shown in the drawings.

In one embodiment (not shown), the hydraulic cylinders are replaced by a jaw actuation mechanism capable of moving the jaws between their opened and closed positions, but that differs from hydraulic cylinders. In one embodiment, this jaw actuation mechanism is a linear actuator that differs from a hydraulic cylinder but still moves linearly.

1. A compact log splitter comprising:
a main body;
a tool coupling member carried by said main body, for operative coupling to a tool handling device;
first and second jaws carried by said main body, said jaws each being movable relative to said main body along a jaw movement direction, said jaws further being movable towards and away from each other between a closed position in which they are near or adjacent to each other and an opened position in which they are spaced-apart compared to said closed position, at least one of said jaws comprising a cutting tool for splitting logs that is in facing register with the other one of said jaws; and
a jaw actuation mechanism carried by said main body and operatively connected to a said first and second jaws, allowing said jaws to be moved between said opened and closed positions;
wherein said compact log splitter has substantially the same width when said jaws are in said opened position and in said closed position, and wherein when said first and second jaws are in said opened position, said jaw actuation mechanism is mostly located between parallel planes that are perpendicular to said jaw movement direction and respectively located at the positions of said first and second jaws.

2. A compact log splitter as defined in claim 1, wherein the width of said compact log splitter is substantially the same as the longest distance between said jaws when they are in said opened position.

3. A compact log splitter as defined in claim 2, further defining a central plane that is perpendicular to said jaw movement direction and located approximately at the same distance from said first jaw and from said second jaw at all positions of said jaws, with the center of gravity of said compact log splitter being located within or close to said central plane.

4. A compact log splitter as defined in claim 3, wherein said jaw actuation mechanism comprises first and second linear actuators each operatively connected to a respective one of said first and second jaws for moving said respective one of said first and second jaws, such that the concurrent actuation of said first and second actuators will move said first and second jaws between said opened and closed positions, wherein said first jaw is movable parallel to said second linear actuator and the second jaw is movable parallel to the first linear actuator when said jaws move between said opened and closed second positions.

5. A compact log splitter as defined in claim 4, wherein said first and second linear actuators respectively comprise first and second hydraulic cylinders each comprising a cylinder barrel attached to one of said main body and a respective one of said first and second jaws, and a piston rod attached to the other one of said main body and a respective one of said first and second jaws, said hydraulic cylinders for connection to a hydraulic circuit allowing selective extraction and retraction of the piston rods of said first and second hydraulic cylinders in opposite directions, wherein the first jaw is movable parallel to the second hydraulic cylinder and the second jaw is movable parallel to the first hydraulic cylinder when said piston rods are extracted and retracted.

6. A compact log splitter as defined in claim 5, wherein said main body comprises first and second parallel elongated housings that carry first and second slider members that are each slidable within a respective one of said first and second housings, with each slide member carrying a respective one of said first and second jaws, and with said hydraulic cylinders each being connected to a respective one of said first and second slider tubes for displacing said slider tubes in said housings when said jaws are displaced between said opened and closed positions.

7. A compact log splitter as defined in claim 6, wherein said slider members are slider tubes that each snugly fit within a respective said housing.

8. A compact log splitter as defined in claim 1, wherein said first jaw comprises a cutting blade and said second jaw comprises an abutment plate in facing register with said cutting blade.

9. A vehicle equipped with a compact log splitter, said vehicle comprising a vehicle body movable over ground, a motor carried by said main body, and a tool arm carried by said main body, said tool arm comprising an arm coupling member, said compact log splitter comprising:
a main body;
a tool coupling member carried by said main body operatively coupled to said arm coupling member of said tool arm;
first and second jaws carried by said main body, said jaws each being movable relative to said main body along a jaw movement direction, said jaws further being movable towards and away from each other between a closed position in which they are near or adjacent to each other and an opened position in which they are spaced-apart compared to said closed position, at least one of said jaws comprising a cutting tool for splitting logs that is in facing register with the other one of said jaws; and
a jaw actuation mechanism carried by said main body and operatively connected to a said first and second jaws, allowing said jaws to be moved between said opened and closed positions;
wherein said compact log splitter has substantially the same width when said jaws are in said opened position and in said closed position, and wherein when said first and second jaws are in said opened position, said jaw actuation mechanism is mostly located between parallel planes that are perpendicular to said jaw movement direction and respectively located at the positions of said first and second jaws.

10. A vehicle equipped with a compact log splitter as defined in claim 9, wherein the width of said compact log splitter is substantially the same as the distance between said jaws when they are in said opened position.

11. A vehicle equipped with a compact log splitter as defined in claim 10, further defining a central plane that is perpendicular to said jaw movement direction and located approximately at the same distance from said first jaw and from said second jaw at all positions of said jaws, said central plane being aligned with said arm coupling member, with the center of gravity of said compact log splitter being located within or close to said central plane.

12. A vehicle equipped with a compact log splitter as defined in claim 11, wherein said jaw actuation mechanism comprises first and second linear actuators each operatively connected to a respective one of said first and second jaws for moving said respective one of said first and second jaws, such that the concurrent actuation of said first and second actuators will move said first and second jaws between said opened and closed positions, wherein said first jaw is movable parallel to said second linear actuator and the second jaw is movable parallel to the first linear actuator when said jaws move between said opened and closed second positions.

13. A vehicle equipped with a compact log splitter as defined in claim 12, wherein said first and second linear actuators respectively comprise first and second hydraulic cylinders each comprising a cylinder barrel attached to one of said main body and a respective one of said first and second jaws, and a piston rod attached to the other one of said main body and a respective one of said first and second jaws, said hydraulic cylinders for connection to a hydraulic circuit allowing selective extraction and retraction of the piston rods of said first and second hydraulic cylinders in opposite directions, wherein the first jaw is movable parallel to the second hydraulic cylinder and the second jaw is movable parallel to the first hydraulic cylinder when said piston rods are extracted and retracted.

14. A vehicle equipped with a compact log splitter as defined in claim 13, wherein said main body comprises first and second parallel elongated housings that carry first and second slider members that are each slidable within a respective one of said first and second housings, with each slide member carrying a respective one of said first and second jaws, and with said hydraulic cylinders each being connected to a respective one of said first and second slider tubes for displacing said slider tubes in said housings when said jaws are displaced between said opened and closed positions.

15. A vehicle equipped with a compact log splitter as defined in claim 14, wherein said slider members are slider tubes that each snugly fit within a respective said housing.
